(19) United States
(12) Patent Application Publication
(10) Pub. No.: US 2008/0312927 A1
(43) Pub. Date: Dec. 18, 2008

(54) Computer assisted interactive writing instruction method

(76) Inventor: Regina Constantin, Woodside, NY (US)

Correspondence Address: JAMES RAY & ASSOCIATES, 2640 PITCAIRN ROAD, MONROEVILLE, PA, 15146, US

(21) Appl. No.: 11/818,434

(22) Filed: Jun. 14, 2007

(51) Int. Cl. G10L 15/00

(52) U.S. Cl. 704/251; 434/350

(57) ABSTRACT

A computer assisted method of instruction for writing that is directed toward students of English as a second language. The method includes instruction for a plurality of composition types with interactive assistance in the writing strategies and tone of writing. The student selects the type of composition and can choose from a plurality of instructions in writing strategy displayed and with audio playback. The student interactively proceeds with writing and revision as the strategies are reviewed until completion of the writing process.

### FIELD OF THE INVENTION

The present invention relates, in general, to computer assisted interactive instruction and, more particularly, this invention relates to instruction for writing.

### BACKGROUND OF THE INVENTION

Prior to the conception and development of the present invention, as is generally well known in the prior art, computer assisted writing tutors. Prior computer assisted writing tutors focused on native language speaker and the technical aspects of written communication such as spelling and grammar. Another form of computer assisted writing instruction focused on the brainstorming for ideas and the creative process.

### SUMMARY OF THE INVENTION

The present invention provides a method of computer assisted instruction directed toward students of English as a second language (“ESL”). ESL students are often competent writers in their native language, but require assistance to overcome the anxiety of writing in a non-native language. While there are similarities in writing in the native language and English, there are also differences in the awareness of tone and voice. The present invention addresses the lack of confidence of the non-native writer as to the requirements for the composition and provides a step-wise method of developing awareness of fundamental of English composition.

### OBJECTS OF THE INVENTION

It is, therefore, one of the primary objects of the present invention to provide a computer assisted method of instruction which systematically addresses the requirements composition.

Another object of the present invention is to provide a reminder of the information required to write a composition.

Still another object of the present invention is to provide instruction for a plurality of forms of written essays.

Yet another object of the present invention is to provide audio instruction.

An additional object of the present invention is to provide a instruction as to writing strategies.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a flow chart of the method.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

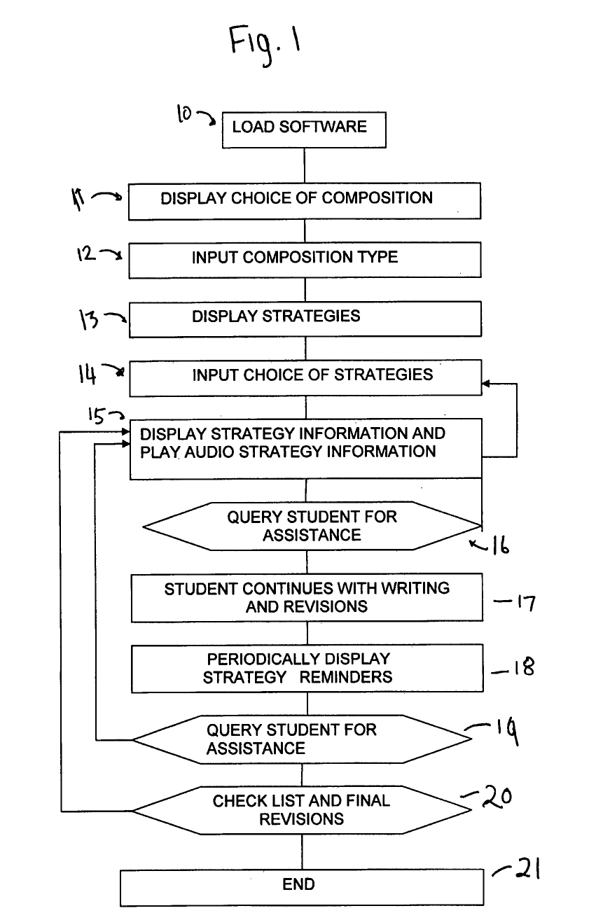

Reference is now made, more particularly, to FIG. 1. The flowchart shows a process of instruction. The student loads the software 10 either after beginning the assigned writing or after a draft.

The software displays a plurality of composition choices 11 for the student requesting the type of composition the student is preparing. The software has prepared instructions for a plurality of essays. In the preferred embodiment, the choices include a group of personal narrative, descriptive, compare and contrast, and literary analysis essays.

The student inputs a composition type 12 and the software displays writing strategies 13. The software is designed for students of English as a second language (“ESL”). ESL students may have proficiency in their native language, but lack the confidence to write in English because of the nuances of tone, usage and style. The present invention provides such instruction to increase the student's proficiency and confidence.

The student inputs a strategy choice 14 and the strategy is displayed visually and with audio playback 15.

As an example of the writing strategies employed, for an augmentative essay, the instructions would include:

State your position

Support your argument

Counter-argument

Means of organization

Control of your position

Select a title that reveals your tone

These strategies would be further developed. As an example the instruction would cover at least the following points for an argumentative essay:

Have you stated your position in the thesis statement? Need help? What is the main idea you will be developing throughout your essay. Be assertive in taking your stand. Remember, your trying to convince your reader of your position . . . so convince me!I want to be on your side, so I need evidence. Prove your point.

Support your argument with facts and details.

Note: be sure to stay on track keeping a tight connection between your points and the thesis. Remember there is a bond . . . a relationship between the two.

Include your Counter-argument with valid reasons to support it. Ok . . . I do see the opponent's point of view, but you need to convince me that your evidence is stronger, more convincing and sound.

Indicate by using transitions your direction from your position to your opponents. Transitions take us from one state to another. Words such as although, however, therefore etc. . . .

What means of organization will you use that is logical in order to persuade the reader of your argument? Should you present the cons points first and give more emphasis on the pro points later?

Is the tone (your attitude) consistent with your topic and your overall writing? Your strength in attitude must permeate throughout the entire essay. There is no room for vagueness or vulnerability! Are you in control of your position?

Be mindful of slanting your information where it may cause an injustice to your argument and credibility as a writer.

Use logic in developing your argument. In other words, don't reach illogical conclusions without given all the facts.

Select a title that reveals your tone. Be mindful of your reader at all times; see things from their point of view as well as yours.

### SUMMARY

Leave the reader with an impression. Remember . . . you are forming a relationship with your reader and they must be confident with the impression you leave them with.

They don't have to like you; they have to respect your conviction with truth of your evidence.

The student is queried whether any assistance is needed 16 and if not the student proceeds 17.

The student receives periodic displays of reminders of strategy 18 and is queried periodically on the strategy choices 19 with the option of the student receiving further displays of visual and audio playback 15. The student then has the option of final checklist 20. The student can then proceed to final revisions and complete the essay 21 or request further display of strategies and audio playback 15.

The displays are available by pull-down menu or popup screens.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A method of interactive computer assisted instruction for writing composition comprising the following steps:
loading software with a database organized by writing composition;
displaying a plurality of written compositions choices;
inputting a choice of written composition;
displaying a plurality of topics choices dependent on the choice of composition;
inputting choice of topics;
displaying writing strategy information dependent on the inputting of a choice of topic;
outputting audio writing strategy information;
querying student as to further assistance, where further assistance is required returning to the previous step of displaying writing strategy information;
continuing with writing and revisions;
displaying periodic suggestions of writing strategy; and
displaying a checklist for in data at the completion of the draft writing process with the option to request further assistance.

2. A method of claim 1 in which the choices of written composition are from a group of personal narrative, descriptive, compare and contrast, and literary analysis essay.

3. A method of claim 1 in which the displaying of writing strategy is by a popup screen.

4. A method of claim 1 in which the choice of topic is displayed by pull-down menu.

5. A method of claim 1 in which the choice of written composition is displayed by pull-down menu.

6. A method of claim 1 in which the writing strategies include stating the position, supporting the argument, counter-argument, means of organization, control of the position and selecting a title that reveals the tone.
